(19) United States
(12) Patent Application Publication
(10) Pub. No.: US 2011/0012554 A1
(43) Pub. Date: Jan. 20, 2011

(54) APPARATUS AND METHOD FOR IMPROVING THE STANDBY EFFICIENCY OF A CHARGER, AND ULTRA LOW STANDBY POWER CHARGER

(75) Inventors: KUN-YU LIN, PINGTUNG COUNTY (TW); TZU-CHEN LIN, TAIPEI CITY (TW); PEI-LUN HUANG, Zhubei City (TW)

Correspondence Address: ROSENBERG, KLEIN & LEE, 3458 ELLICOTT CENTER DRIVE-SUITE 101, ELLICOTT CITY, MD, 21043, US

(73) Assignee: RICHPOWER MICROELECTRONICS CORPORATION, GRAND CAYMAN (KY)

(21) Appl. No.: 12/832,441

(22) Filed: Jul. 8, 2010

(30) Foreign Application Priority Data
Jul. 14, 2009 (TW) 098123806

(51) Int. Cl. H02J 7/00

(52) U.S. Cl. 320/107

(57) ABSTRACT

A charger has two pins for connecting with a battery therebetween, and an apparatus and method are proposed to determine to wake up or turn off the charger according to a voltage or a current detected from the two pins, to reduce the standby power consumption of the charger.

### FIELD OF THE INVENTION

The present invention is related generally to battery chargers and, more particularly, to apparatus and method for improving the standby efficiency of a charger.

### BACKGROUND OF THE INVENTION

Recently, due to shortage of energy sources and with environmental awareness on the rise, various energy saving functions attract more and more attention in applications of power supplies, of which the standby power consumption is one of the key factors. As shown in FIG. 1, a typical battery charger 10 has two pins VCC and IS for connecting with a battery 12 therebetween, and a flyback voltage converter 14 for charging the battery 12. In the voltage converter 14, a transformer Tx has a primary coil Lp connected between a power input end Vin and a power switch Qsw, and a secondary coil Ls connected between a diode Do and a ground end GND, a power controller 16 provides a pulse width modulation (PWM) signal Vgs from a pin GATE to switch the power switch Qsw and thereby control the power delivery of the transformer Tx, and the transformer Tx further includes an auxiliary coil Laux connected between a ground end GND and a diode Daux to supply a current Iaux for charging a capacitor Cvdd and thereby providing electricity to a power pin VDD of the power controller 16. A constant current/constant voltage (CC/CV) controller 18 detects a voltage from the pin VCC and a current from the pin IS and according thereto, generates a feedback signal FB with an optical coupler 20 to feed back to a pin COMP of the power controller 16. A current sense resistor Rcs is connected in series with the power switch Qsw to detect the current in the primary coil Lp to generate a current sense signal VCS injected into a current sense pin CS of the power controller 16. The power controller 16 modulates the duty of the power switch Qsw according to the feedback signal FB and the current sense signal VCS.

During the charger 10 charging a battery 12, the CC/CV controller 18 controls the flyback voltage converter 14 with the optical coupler 20 to operate the charger 10 in a constant current mode or a constant voltage mode. The constant current mode charges the battery 12 with a constant current IS under a voltage VCC higher than the battery voltage Vb. In this mode, with the lapse of charging time, the battery 12 stores energy through a reverse chemical reaction, and the battery voltage Vb increases as a result. To continue charging the battery 12, the charger 10 keeps the voltage VCC higher than the battery voltage Vb. However, as the battery 12 is gradually saturated, an upper limit must be set for the increasing battery voltage Vb to control the battery voltage Vb effectively; otherwise, an excessively high battery voltage Vb may damage the battery 12 permanently. Therefore, as soon as the battery voltage Vb reaches a preset value, the CC/CV controller 18 switches the charger 10 to the constant voltage mode, in which the battery 12 is charged under a constant voltage VCC higher than the battery voltage Vb. In the constant voltage mode, the difference between the voltage VCC and the battery voltage Vb gradually narrows as the battery voltage Vb approaches the voltage VCC; therefore, the charging decelerates. When the battery voltage Vb finally reaches the voltage VCC, meaning the battery 12 is saturated, the charger 10 enters a standby mode. If the battery 12 is removed from the charger 10 before the battery 12 is saturated, the charger 10 will also enter the standby mode. In the standby mode, if electricity is supplied to the power input end Vin of the flyback voltage converter 14, the flyback voltage converter 14 will keep operating and hence incur certain losses, such as switching loss and conduction loss, which contribute to considerable standby power consumption of the charger 10.

Therefore, it is desired an apparatus and method for reducing the standby power consumption of a charger.

### BRIEF SUMMARY OF THE INVENTION

An object of the present invention is to provide an apparatus and method for reducing the standby power consumption of a charger.

Another object of the present invention is to provide an apparatus and method for removing the switching loss and conduction loss of a charger in a standby mode.

Yet another object of the present invention is to provide an apparatus and method for improving the standby efficiency of a charger.

Still another object of the present invention is to provide an ultra low standby power charger.

According to the present invention, an apparatus for improving the standby efficiency of a charger includes a power monitor circuit connected to two pins of the charger to detect the voltage and the current therefrom, respectively, to generate a control signal. The control signal will disable the charger in a standby mode to reduce the standby power consumption.

According to the present invention, a method for improving the standby efficiency of a charger includes detection of a voltage and a current from two pins of the charger, and generation of a control signal according to the voltage and the current. The control signal will disable the charger in a standby mode to reduce the standby power consumption.

According to the present invention, an ultra low standby power charger includes two pins for connecting with a battery therebetween, a voltage converter for supplying electricity to and thereby charging the battery, and a power monitor circuit connected to the two pins to generate a control signal according to the voltage and the current detected from the two pins. The control signal will disable the voltage converter in a standby mode to reduce the standby power consumption.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a circuit diagram of a conventional battery charger;

FIG. 2 is a circuit diagram of an ultra low standby power charger according to the present invention;

FIG. 3 is a circuit diagram of an embodiment for the power monitor circuit shown in FIG. 2; and

FIG. 4 is a waveform diagram of a battery charging process according to the present invention.

### DETAILED DESCRIPTION OF THE INVENTION

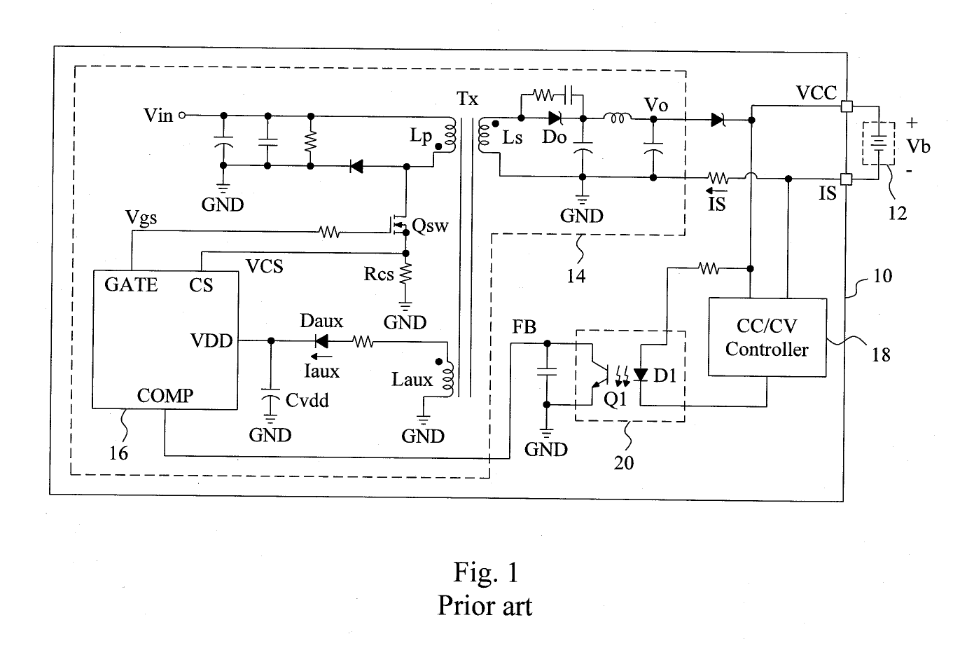

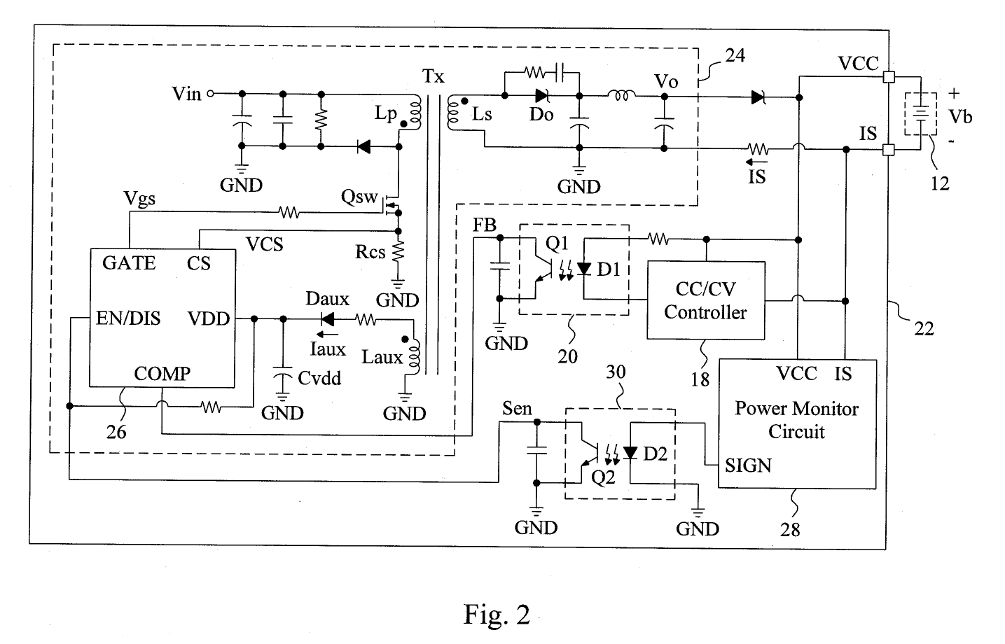

FIG. 2 is a circuit diagram of an embodiment according to the present invention, in which a charger 22 is similar to the charger 10 of FIG. 1 in that the charger 22 includes two pins VCC and IS for connecting with a battery 12 therebetween, a flyback voltage converter 24 having a power controller 26 to switch a power switch Qsw with a PWM signal Vgs to control the power delivery output from the flyback voltage converter 24, a CC/CV controller 18 for controlling the charger 22 to operate in a constant current mode or a constant voltage mode, and an optical coupler 20 for providing a feedback signal FB applied to a pin COMP of the power controller 26 for the power controller 26 to modulate the duty of the power switch Qsw according to the feedback signal FB and a current sense signal VCS. However, in the charger 22, there are introduced a power monitor circuit 28 connected to the pins VCC and IS for generating a control signal SIGN according to the voltage VCC and the current IS detected from the pins VCC and IS, and an optical coupler 30 for converting the control signal SIGN into an enable signal Sen applied to a pin EN/DIS of the power controller 26.

A battery, be it brand new or short of electricity, must be left with certain voltage due to chemical reaction in the battery. Immediately after the battery 12 inserted into the charger 22 and before the flyback voltage converter 24 operating, the voltage at the pin VCC will be the battery voltage Vb of the battery 12, and the power monitor circuit 28 may detect the battery voltage Vb left in the battery 12 from the pin VCC in this case.

If the battery voltage Vb is lower than a first threshold value V_{CC}_{_{—}}_{L}, the battery 12 is recognized as damaged, and the charger 22 will not charge the battery 12. If the battery voltage Vb is between the first threshold value V_{CC}_{_{—}}_{L} and a second threshold value V_{CC}_{_{—}}_{H}, the power monitor circuit 28 will wake up the charger 22. In this case, the control signal SIGN is low and thus no current flows through a light emitting diode D2 in the optical coupler 30. As a result, a transistor Q2 in the optical coupler 30 is off and thus the enable signal Sen is high, having the charger 22 charging the battery 12.

While the charger 22 is in a charging mode, the voltage at the pin VCC is approximately equal to the output voltage Vo of the flyback voltage converter 24 and according to the voltage detected from the pin VCC and the current detected from the pin IS, the power monitor circuit 30 keeps the control signal SIGN at low, such that the power controller 26 continues switching the power switch Qsw. The CC/CV controller 18 controls the charger 22 to operate in the constant current mode or the constant voltage mode, as it did conventionally. When the battery 12 is charged to a rated voltage such that the voltage detected from the pin VCC is higher than the second threshold value V_{CC}_{_{—}}_{H} and the current detected from the pin IS is lower than a third threshold value V_{IS}_{_{—}}_{L}, the power monitor circuit 28 disables the charger 22 and brings it into a standby mode. At this time, the control signal SIGN is high and in consequence, the enable signal Sen generated by the optical coupler 30 is low. Thus, the power controller 26 is disabled and stops switching the power switch Qsw. If, in a different scenario, the charger 22 has charged the battery 12 for a preset period of time, but the voltage detected from the pin VCC still has not reached the second threshold value V_{CC}_{_{—}}_{H}, or the current detected from the pin IS still has not been lower than the third threshold value V_{IS}_{_{—}}_{L}, the power monitor circuit 28 will also pull high the control signal SIGN to disable the power controller 28, with a view to saving energy and preventing the battery 12 from being overheated due to an excessively long charging time. This function is accomplished only by providing a timer in the power monitor circuit 28.

When the battery 12 is removed from the charger 22, the power monitor circuit 28 immediately detects the current detected from the pin IS becoming lower than the third threshold value V_{IS}_{_{—}}_{L} and thereupon, pulls high the control signal SIGN to disable the power controller 26 for energy saving.

While the charger 22 is in the standby mode, the CC/CV controller 18 may operate in a standby fashion upon the battery voltage Vb provided by the battery 12 and disable all unnecessary functions of the charger 22 to minimize power consumption. When electricity stored in the battery 12 is consumed to such extent that the battery voltage Vb is lower than a fourth threshold value V_{cc}_{_{—}}_{H}_{_{—}}_{hys}, the control signal SIGN once again turns to low to reactivate the charger 22. In the standby mode, since the power controller 26 is disabled, and the power switch Qsw is not switched, neither switching loss nor conduction loss occurs, and in consequence the efficiency of the charger 22 is improved.

When the charger 22 is in the standby mode, the power monitor circuit 28 disables the flyback voltage converter 24 to prevent both switching loss and conduction loss and thereby reduce power consumption.

The power monitor circuit 28 and the CC/CV controller 18 may be integrated in a single chip.

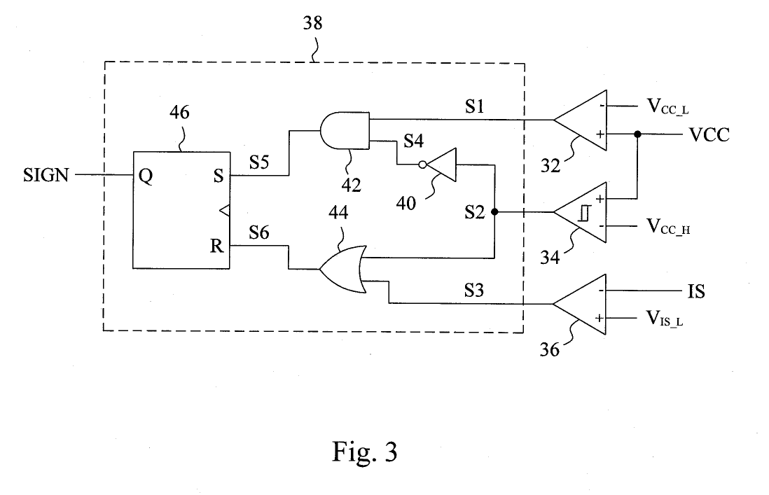

FIG. 3 is a circuit diagram of an embodiment for the power monitor circuit 28 shown in FIG. 2, in which a comparator 32 compares the voltage VCC with the first threshold value V_{CC}_{_{—}}_{L} to generate a signal S1, a hysteresis comparator 34 compares the voltage VCC with the second threshold value V_{CC}_{_{—}}_{H} to generate a signal S2, a comparator 36 compares the current IS with the third threshold value V_{IS}_{_{—}}_{L} to generate a signal S3, and a logic circuit 38 generates the control signal SIGN according to the signals S1, S2 and S3. In this embodiment, an inverter 40 inverts the signal S2 into a signal S4, an AND gate 42 generates a signal S5 according to the signals S1 and S4, an OR gate 44 generates a signal S6 according to the signals S2 and S3, the signals S5 and S6 are provided to a set input end S and a reset input end R of a flip-flop 46, respectively, and the output Q of the flip-flop 46 is the control signal SIGN. When the voltage VCC is lower than the first threshold value V_{CC}_{_{—}}_{L}, the signal S1 is low, and therefore the control signal SIGN is not triggered. When the voltage VCC increases to higher than the second threshold value V_{CC}_{_{—}}_{H}, the signal S2 transits to high and resets the control signal SIGN. Once the signal S2 becomes high, owing to the hysteresis of the hysteresis comparator 34, the signal S2 will not transit back to low to trigger the control signal SIGN unless the voltage VCC falls below the fourth threshold value V_{CC}_{_{—}}_{H}_{_{—}}_{hys}. If the current IS falls below the third threshold value V_{IS}_{_{—}}_{L} during a charging period, the signal S3 will transit to high to reset the control signal SIGN.

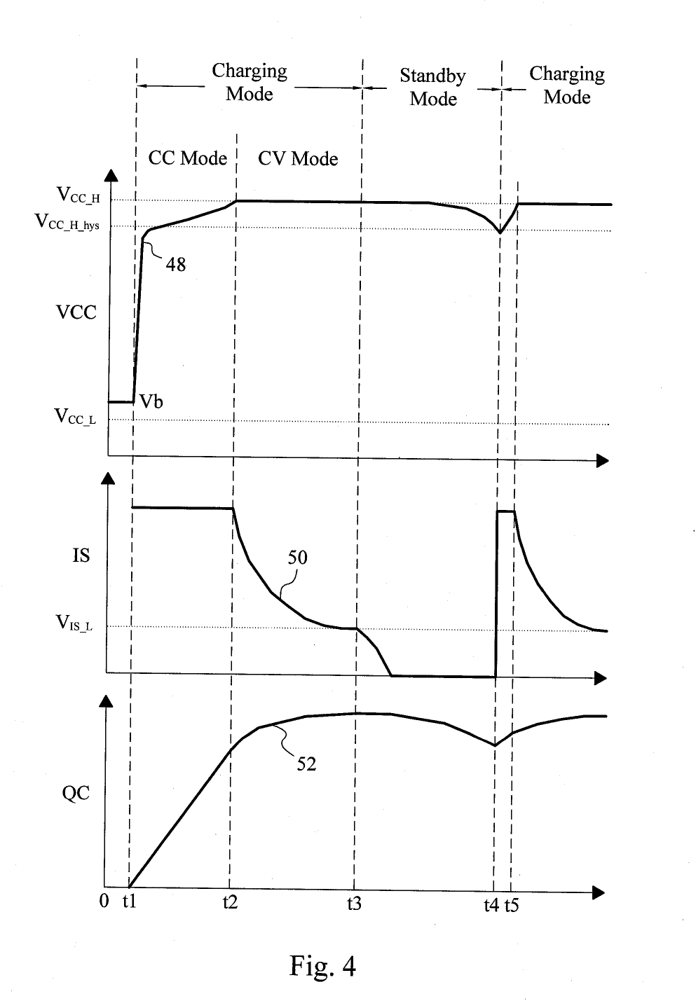

FIG. 4 is a waveform diagram of a battery charging process according to the present invention, in which waveform 48 represents the voltage VCC, waveform 50 represents the current IS, and waveform 52 represents the battery capacity QC. Immediately after the battery 12 inserted into the charger 22, the voltage detected from the pin VCC is equal to the battery voltage Vb, which is higher than the first threshold value V_{CC}_{_{—}}_{L} and thus indicates the battery 12 is normal, but is lower than the second threshold value V_{CC}_{_{—}}_{H} such that the charger 22 enters the charging mode at time t1. Following that, the voltage VCC increases rapidly, the current IS remains constant, and the battery capacity QC increases linearly. At time t2, as the voltage VCC rises to the second threshold value V_{CC}_{_{—}}_{H}, the charger 22 is switched from the constant current mode to the constant voltage mode, in which the voltage VCC remains constant, the current IS gradually decreases, and the battery capacity QC increases at a lower speed. At time t3, the current IS decreases to the third threshold value V_{IS}_{_{—}}_{L}, so the charger 22 enters the standby mode, in which the current IS keeps decreasing. In the standby mode, the battery 12 provides electricity to the CC/CV controller 18 and the power monitor circuit 28; therefore, the electricity consumed causes a slight decrease in the battery capacity QC and the voltage VCC also decreases slightly. At time t4, the voltage VCC becomes as low as the fourth threshold value V_{CC}_{_{—}}_{H}_{_{—}}_{hys}, so the charger 22 is reactivated and begins to operate in the constant current mode. Later at time t5, the charger 22 is switched from the constant current mode to the constant voltage mode. In the standby mode, i.e., from time t3 to time t4, the charger 22 is disabled whenever the battery 12 is saturated or removed from the charger 22, and only the CC/CV controller 18 and the power monitor circuit 28 consume a very small amount of power; thus, the charger 22 has ultra low standby power.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An apparatus for improving the standby efficiency of a charger including two pins for connecting with a battery therebetween and a voltage converter for being operative to use a power controller to switch a power switch, the apparatus comprising:
a power monitor circuit connected to the two pins, operative to generate a control signal according to a voltage and a current detected from the two pins, respectively; and
an optical coupler connected to the power monitor circuit, for converting the control signal into an enable signal to enable or disable the power controller.

2. The apparatus of claim 1, wherein the power monitor circuit enables the power controller in a charging mode and disables the power controller in a standby mode.

3. The apparatus of claim 1, wherein the power monitor circuit comprises:
a first comparator for comparing the voltage with a first threshold value to generate a first signal;
a hysteresis comparator for comparing the voltage with a second threshold value to generate a second signal;
a second comparator for comparing the current with a third threshold value to generate a third signal; and
a logic circuit connected to the first comparator, the hysteresis comparator, and the second comparator to determine the control signal according to the first signal, the second signal, and the third signal.

4. The apparatus of claim 3, wherein the logic circuit comprises:
an inverter connected to the hysteresis comparator to generate a fourth signal by inverting the second signal;
an AND gate connected to the first comparator and the inverter to generate a fifth signal according to the first signal and the fourth signal;
an OR gate connected to the hysteresis comparator and the second comparator to generate a sixth signal according to the second signal and the third signal; and
a flip-flop having a set input end for receiving the fifth signal, a reset input end for receiving the sixth signal, and an output end for generating the control signal.

5. The apparatus of claim 2, wherein the power monitor circuit switches the control signal to disable the power controller if the charging mode has continued for a preset period of time but the voltage still has not reached a particular threshold value.

6. The apparatus of claim 2, wherein the power monitor circuit switches the control signal to disable the power controller if the charging mode has continued for a preset period of time but the current still has not been lower than a particular threshold value.

7. A method for improving the standby efficiency of a charger including two pins for connecting with a battery therebetween, the method comprising the steps of:
(A) detecting a voltage and a current from the two pins, respectively;
(B) generating a control signal according to the voltage and the current;
(C) enabling the charger with the control signal in a charging mode; and
(D) disabling the charger with the control signal in a standby mode.

8. The method of claim 7, wherein the step (B) comprises the steps of:
comparing the voltage with a first threshold value to generate a first signal;
hysteretically comparing the voltage with a second threshold value to generate a second signal;
comparing the current with a third threshold value to generate a third signal; and
determining the control signal according to the first signal, the second signal, and the third signal.

9. The method of claim 7, wherein the step (B) comprises the step of switching the control signal to disable the charger when the current is lower than a particular threshold value in the charging mode.

10. The method of claim 7, wherein the step (B) comprises the step of switching the control signal to enable the charger when the voltage is lower than a particular threshold value in the standby mode.

11. The method of claim 7, wherein the step (B) comprises the step of switching the control signal to disable the charger if the charging mode has continued for a preset period of time but the voltage still has not reached a particular threshold value.

12. The method of claim 7, wherein the step (B) comprises the step of switching the control signal to disable the charger if the charging mode has continued for a preset period of time but the current still has not been lower than a particular threshold value.

13. An ultra low standby power charger, comprising:
two pins for connecting with a battery therebetween;
a voltage converter for providing electricity to and thereby charging the battery; and
a power monitor circuit connected to the two pins, operative to generate a control signal according to a voltage and a current detected from the two pins, respectively, to enable or disable the voltage converter.

14. The ultra low standby power charger of claim 13, wherein the power monitor circuit enables the voltage converter in a charging mode and disables the voltage converter in a standby mode.

15. The ultra low standby power charger of claim 13, further comprising an optical coupler connected to the power monitor circuit for converting the control signal into an enable signal for the voltage converter.

16. The ultra low standby power charger of claim 14, wherein the power monitor circuit switches the control signal to disable the voltage converter if the charging mode has continued for a preset period of time but the voltage still has not reached a particular threshold value.

17. The ultra low standby power charger of claim 14, wherein the power monitor circuit switches the control signal to disable the voltage converter if the charging mode has continued for a preset period of time but the current still has not been lower than a particular threshold value.
